(19) United States
(12) Patent Application Publication
(10) Pub. No.: US 2017/0090929 A1
(43) Pub. Date: Mar. 30, 2017

(54) HARDWARE-ASSISTED SOFTWARE VERIFICATION AND SECURE EXECUTION

(71) Applicant: McAfee, Inc., Santa Clara, CA (US)

(72) Inventors: Igor Muttik, Berkhamsted (GB); Boris A. Babayan, Moscow (RU); Alexander V. Ermolovich, Moscow (RU); Alexander Y. Ostanevich, Moscow (RU); Sergey A. Rozhkov, Santa Clara, CA (US)

(73) Assignee: McAfee, Inc., Santa Clara, CA (US)

(21) Appl. No.: 14/865,511

(22) Filed: Sep. 25, 2015

(51) Int. Cl. G06F 9/30; G06F 21/56

(52) U.S. Cl. CPC G06F 9/30145; G06F 9/30021; G06F 9/30058; G06F 21/562

(57) ABSTRACT

In an example, there is disclosed a computing apparatus, including a processor operable to execute a plurality of instructions forming a program; and a verification engine, operable to: receive an execution control data (ECD) for the program; and monitor execution of only some instructions of the program to ensure that they are consistent with the ECD. In some embodiments, the monitoring engine may include a correctness monitoring unit (CMU) in processor hardware. There is also disclosed one or more computer-readable storage mediums having stored thereon executable instructions for providing a monitoring engine, and a computer-implemented method of providing a monitoring engine.

### FIELD OF THE SPECIFICATION

This disclosure relates in general to the field of computer security, and more particularly, though not exclusively to, a system and method for hardware-assisted software verification and secure execution.

### BACKGROUND

It has become an unfortunate reality of modern life that even as computers become ever increasingly intertwined with our lives and lifestyles, they also prove themselves to be not wholly reliable. In particular, software bugs are a significant burden on modern society. Bugs may arise from malicious code injection, or simply because a programmer makes a mistake while programming software. These mistakes are not always obvious. Even a programmer following good programming practice may run into situations where a compiler makes an optimization that is perfectly logical for the compiler, but that has unexpected consequences from the programmer's perspective. This can introduce security flaws, crashes, and other dangerous behavior in software.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 is a block diagram of a security-enabled network according to one or more examples of the present specification.

FIG. 2 is a block diagram of a computing device according to one or more examples of the present specification.

FIG. 3 is a block diagram of a server according to one or more examples of the present specification.

FIG. 4 is a block diagram of a processor according to one or more examples of the present specification.

FIG. 5 is a block diagram illustration of a program under analysis according to one or more examples of the present specification.

FIG. 6 is a flow chart of a method according to one or more examples of the present specification.

### SUMMARY

In an example, there is disclosed a computing apparatus, including a processor operable to execute a plurality of instructions forming a program; and a verification engine, operable to: receive an execution control data (ECD) for the program; and monitor execution of only some instructions of the program to ensure that they are consistent with the ECD. In some embodiments, the monitoring engine may include a correctness monitoring unit (CMU) in processor hardware. There is also disclosed one or more computer-readable storage mediums having stored thereon executable instructions for providing a monitoring engine, and a computer-implemented method of providing a monitoring engine.

### Embodiments of the Disclosure

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments many have different advantages, and no particular advantage is necessarily required of any embodiment.

Contemporary computers do not generally guarantee correct software execution. Indeed, all known computing platforms are plagued by software vulnerabilities in one form or another. The number and severity of software vulnerabilities shows no sign of abating.

For example, one very old and well-understood software vulnerability is the so-called “buffer overflow.” In a buffer overflow, a block of memory (a “buffer”) is allocated for holding a particular value or string. If an over-long string is written into the buffer, such as by an attacker or other malicious actor, the attacker may be able to modify the target process's memory space. This may enable the attacker to, for example, modify function pointers or return addresses to point to malware routines. Yet even this well-understood vulnerability continues to rise, and sometimes arises in nonobvious contexts.

Some modern exploits may even successfully operate without injecting any external code intro platform, but may rather stitch together already existing and trusted code fragments (the attack technique also known as return/jump/call oriented programming exploitation: ROP/JOP/COP). Many other vulnerabilities exist because of incorrect software design, such as poor crypto implementations, poor input validation, and poor program logic to name just a few nonlimiting examples. Such exploits are particularly dangerous in a modern setting where users' lives are increasingly stored online. Exploits can compromise passwords, financial data, bank accounts and other financial instruments, personal documents, personally-identifying data, private photographs, and other private information. In a hyper-connected society, data leaks can lead to both loss of privacy and compromise of personal safety.

Incorrect software also has economic implications. Computer users are all too familiar with operating systems and software packages constantly slowing down, rebooting, or restarting, as the programs plead for or automatically install security updates. On the vendor side, this can interrupt work flow and cause a decrease in productivity as users are taken off-task. Constantly rolling out such updates is also expensive for the software vendor, who must pay programmers to analyze and patch security vulnerabilities on an ongoing basis, sometimes for software that is many years old and that is no longer a source of practical, ongoing revenue. On the enterprise scale, important updates may also need to be tested in a safe environment to ensure that they will not break compatibility with existing systems and networks.

One method of mitigating software vulnerabilities is formal code proof. Where near-total software assurance is necessary, such as in nuclear, military, real-time, control system, medical, finance, aerospace, automotive, critical infrastructure, and similar systems, it may be desirable and practical to formally “prove” that a software package performs as expected. Formal software verification may include, by way of nonlimiting example, deductive proof, abstract interpretation, automated theorem proving, type systems, and lightweight formal methods. In some examples, a program may be formally derived from a functional specification by operations that preserve the correctness of the specification, such as in “Bird-Meertens Formalism.”

In existing practice, formally proving software can be very technical and time-consuming. For example, approximately 20 “man years” were expended formally proving the L4 Linux microkernel, which had approximately 10,000 lines of C code (for comparison, the full stock Linux kernel, as of version 4.1.3, has approximately 15.7 million lines of code). Thus, while full formal proof of correctness is a very desirable outcome, the cost and effort may be too great to be practical for large, mass-produced software packages, because many known formal proof systems simply do not scale well. Thus, the applicants of the present specification have recognized that it is desirable to provide a system and method that realizes the advantages of formal proofs, but that is more practical for enterprise-scale systems, and that is scalable and thus more reasonably implemented on an enterprise scale.

In an example of the present specification, a correctness monitoring unit (CMU) is provided within a processor to combine static analysis software correctness with runtime monitoring of correct execution. In one example, the CMU is provided entirely in hardware, as an integrated part of the CPU, to ensure fast execution. In other examples, the CMU may be provided as any combination of hardware, software, firmware, or other logic elements suitable for performing the method. An example method may include the following operations:
1. Perform preliminary correctness analysis on the subject software, either based on the software source code, or if the source code is not available, based on the program binary code by applying automated static analysis tools. The analysis extracts execution control data (ECD) about the expected software behavior, including code flow and data flows.
2. For all code fragments, including for example programs, modules, threads, sequences, and similar, where it is not practical or not possible to perform full formal code analysis (such as where it is too resource or time-consuming to do so) save the ECD.
3. Load the ECD data into CPU buffers at runtime.
4. During program execution, the CMU monitors actual execution flow and data flow. The CMU compares these with loaded expected ECD data, and raises an exception if they do not match.

Advantageously, the system and method of the present specification provides beneficial exploit mitigation. Deviations from expected code flows terminate even hard-to-detect exploits, because those code flows will be completely out of sync with the expected results from code analysis and will thus raise an exception. Many other exploits and attacks may be uncovered via discovery of unexpected data flows, such as external user input or Internet data flowing into subsequently executed RAM addresses.

Further advantageously, reliability and performance benefits are realized. As described above, full static analysis of correctness can be very expensive, and may not always be reliable. For example, when the Linux L4 microkernel C code was converted into Haskell for further analysis, certain assumptions were necessarily made and some shortcuts taken, such as compiler correctness was assumed. Thus, it is desirable to complement static correctness analysis with dynamic runtime verification. This can be especially important when the static correctness proof step is not definitive and uses assumptions.

Further advantageously, software quality assurance benefits are provided. Increased levels of quality control and assurance about software via real-time debugging capabilities based on deviations from expected software behavior can be provided.

In various examples, any suitable method may be used to extract the ECD from the source code or program binary code. These may include, by way of non-limiting example:
1. Primitive dynamic “taint tracking” methods, such as recording all memory locations where external/untrusted data could have propagated in.
2. Symbolic program analysis (a.k.a. symbolic execution) for data flow extraction.
3. Reverse-engineering tools like Interactive Dis-Assembler (IDA), available from Hex Rays.
4. De-compilation and control-flow graphs (CFGs).

Strictly speaking, data flows may be analyzed for the entire computing device, not for a single program. To be able to apply flow control only to software modules, certain assumptions may be made, such as that the operating system (OS) provides perfect isolation of software modules. This can be supported by better isolation in the CPU. Indeed, enhanced isolation may be a prerequisite for software analysis. In other examples, data flows originating from the OS may be classified as trusted, and others may be identified as untrusted. Another alternative is to perform the ECD extraction from the OS source code (if available).

In some cases, software source code is not publicly available for proprietary software. To support run-time correctness monitoring, it may be convenient to extract the ECD at the time of building software for distribution (such as in “a build room”), cryptographically sign the ECD (using, for example, PKI methods), provide a relationship information about the program and its ECD, and distribute either the actual signed ECD or a link (URL) to the relevant information (e.g. a URL to a digitally signed table containing hashes of programs and ECD data structures).

When software includes multiple modules, the source code may only be available for some of them (e.g. shared Windows DLLs or Linux SOs may have neither sources to extract ECD data nor extracted-at-build and digitally signed ECDs). In this case, the ECD for these software modules may be statically extracted from the binaries.

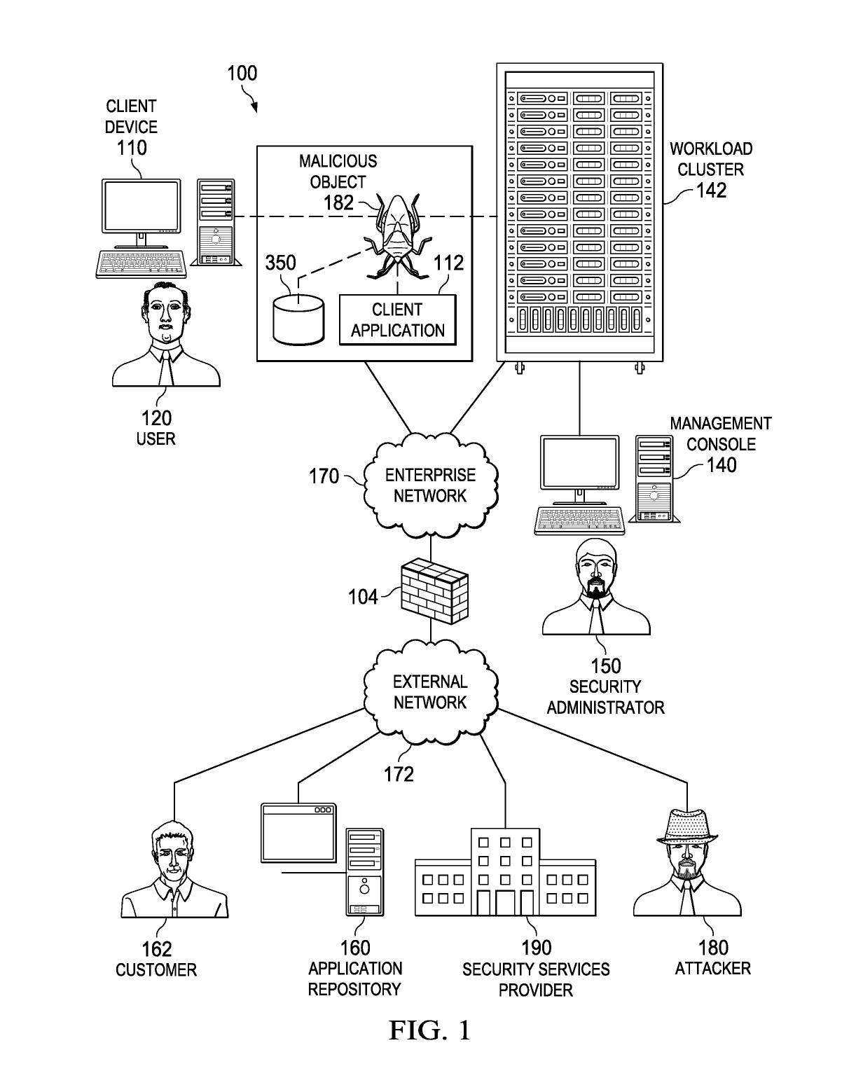

A system and method for hardware-assisted software verification will now be described with more particular reference to the attached figures. FIG. 1 is a network-level diagram of a secured enterprise 100 according to one or more examples of the present specification. In the example of FIG. 1, one or more users 120 operate one or more client devices 110. Each device may include an appropriate operating system, such as Microsoft Windows, Linux, Android, Mac OSX, Apple iOS, Unix, or similar. Some of the foregoing may be more often used on one type of device than another. For example, desktop computers or engineering workstation may be more likely to use one of Microsoft Windows, Linux, Unix, or Mac OSX. Laptop computers, which are usually a portable off-the-shelf device with fewer customization options, may be more likely to run Microsoft Windows or Mac OSX. Mobile devices may be more likely to run Android or iOS. However, these examples are not intended to be limiting.

Client devices 110 may be communicatively coupled to one another and to other network resources via enterprise network 170. Enterprise network 170 may be any suitable network or combination of one or more networks operating on one or more suitable networking protocols, including for example, a local area network, an intranet, a virtual network, a wide area network, a wireless network, a cellular network, or the Internet (optionally accessed via a proxy, virtual machine, or other similar security mechanism) by way of nonlimiting example. Enterprise network 170 may also include one or more servers, firewalls, routers, switches, security appliances, antivirus servers, or other useful network devices, which in an example may be virtualized within workload cluster 142. In this illustration, enterprise network 170 is shown as a single network for simplicity, but in some embodiments, enterprise network 170 may include a large number of networks, such as one or more enterprise intranets connected to the internet. Enterprise network 170 may also provide access to an external network, such as the Internet, via external network 172. External network 172 may similarly be any suitable type of network.

A workload cluster 142 may be provided, for example as a virtual cluster running in a hypervisor on a plurality of rack-mounted blade servers, or as a cluster of physical servers. Workload cluster 142 may provide one or more server functions, or one or more “microclouds” in one or more hypervisors. For example, a virtualization environment such as vCenter may provide the ability to define a plurality of “tenants,” with each tenant being functionally separate from each other tenant, and each tenant operating as a single-purpose microcloud. Each microcloud may serve a distinctive function, and may include a plurality of virtual machines (VMs) of many different flavors, including agentful and agentless VMs.

It should also be noted that some functionality of endpoint devices 110 may also be provided via workload cluster 142. For example, one microcloud may provide a remote desktop hypervisor such as a Citrix workspace, which allows users 120 operating endpoints 110 to remotely login to a remote enterprise desktop and access enterprise applications, workspaces, and data. In that case, endpoint 110 could be a “thin client” such as a Google Chromebook, running only a stripped-down operating system, and still provide user 120 useful access to enterprise resources.

In some embodiments, workload cluster 142 may provide one or more nodes for performing centralized ECD generation via an ECD server engine. For example, enterprise security policies may require programs to have an approved ECD in place before they are allowed to execute on enterprise computing resources. Thus, “gray” objects are provided to an ECD server, which analyzes the program to create an ECD for that program. An object may not receive a formal designation as “whitelisted” unless and until it has been subjected to formal analysis, which may include one or both of automated analysis and human analysis. This may comprise formally verifying portions of the program that are reasonably subject to formal verification (which may depend on factors such as the size of the program, complexity of the program, importance of the program, or resources available to the enterprise). Any portions that are formally verified may be marked as “known good,” and at least those portions of the program may have a “white” reputation. Other portions of the program may not be reasonably subject to formal verification. For these portions, the ECD server may save an ECD file or other similar object to be used concurrently with execution of the program, as described in more detail below.

One or more computing devices configured as a management console 140 may also operate on enterprise network 170. Management console 140 may provide a user interface for a security administrator 150 to define enterprise security policies, which management console 140 may enforce on enterprise network 170 and across client devices 110 and workload cluster 142. In an example, management console 140 may run a server-class operating system, such as Linux, Unix, or Windows Server. In other case, management console 140 may be provided as a web interface, on a desktop-class machine, or via a VM provisioned within workload cluster 142.

Secured enterprise 100 may encounter a variety of “security objects” on the network. A security object may be any object that operates on or interacts with enterprise network 170 and that has actual or potential security implications. In one example, security objects may be broadly divided into hardware objects, including any physical device that communicates with or operates via the network, and software objects. Software objects may be further subdivided as “executable objects” and “static objects.” Executable objects include any object that can actively execute code or operate autonomously, such as applications, drivers, programs, executables, libraries, processes, runtimes, scripts, macros, binaries, interpreters, interpreted language files, configuration files with inline code, embedded code, and firmware instructions by way of non-limiting example. A static object may be broadly designated as any object that is not an executable object or that cannot execute, such as documents, pictures, music files, text files, configuration files without inline code, videos, and drawings by way of non-limiting example. In some cases, hybrid software objects may also be provided, such as for example a word processing document with built-in macros or an animation with inline code. For security purposes, these may be considered as a separate class of software object, or may simply be treated as executable objects.

Secured enterprise 100 may also provide goods or services to a customer 162 or other end user. Incident to procuring goods and services, customer 162 may provide personally-identifying information (PII) and other private or sensitive data. Such data may be referred to throughout this specification as “sensitive user data,” which term is intended to be broadly construed to include any data that user 162 does not want broadly known, disseminated, sold, or otherwise misappropriated. Secured enterprise 100 may have a privacy policy with customer 162, or may be bound by laws or regulations that limit secured enterprise 100's use or dissemination of sensitive user data. Thus, if sensitive user data are lost, or misappropriated by a malicious actor such as attacker 190, secured enterprise may be subject to legal action, or may at least suffer loss of reputation or business value. It is therefore in secured enterprise 100's interest to properly secure sensitive user data.

Secured enterprise 100 may communicate across enterprise boundary 104 with external network 172. Enterprise boundary 104 may represent a physical, logical, or other boundary. External network 172 may include, for example, websites, servers, network protocols, and other network-based services. In one example, an application repository 160 is available via external network 172, and an attacker 180 (or other similar malicious or negligent actor) also connects to external network 172. A security services provider 190 may provide services to secured enterprise 100. In certain embodiments, security services provider 190 may contract to provide ECDs for commercial software as a third-party service. For example, a software vendor providing software over application repository 160 may not wish to disclose its source code to all of its customers, and may instead contract for security services provider 190 to perform analysis of all of its software, and provide ECDs to customers. In other examples, secured enterprise 100 may subcontract security services provider 190 to analyze software and provide ECDs.

It may be a goal of users 120 and secure enterprise 100 to successfully operate client devices 110 and workload cluster 142 without interference from attacker 180 or from unwanted security objects. In one example, attacker 180 is a malware author whose goal or purpose is to cause malicious harm or mischief, for example by injecting malicious object 182 into client device 110. Once malicious object 182 gains access to client device 110, it may try to perform work such as social engineering of user 120, a hardware-based attack on client device 110, modifying storage 350 (FIG. 3), modifying client application 122 (which may be running in memory), or gaining access to enterprise servers 142.

The malicious harm or mischief may take the form of installing root kits or other malware on client devices 110 to tamper with the system, installing spyware or adware to collect personal and commercial data, defacing websites, operating a botnet such as a spam server, or simply to annoy and harass users 120. Thus, one aim of attacker 180 may be to install his malware on one or more client devices 110. As used throughout this specification, malicious software (“malware”) includes any security object configured to provide unwanted results or do unwanted work. In many cases, malware objects will be executable objects, including by way of non-limiting examples, viruses, Trojans, zombies, rootkits, backdoors, worms, spyware, adware, ransomware, dialers, payloads, malicious browser helper objects, tracking cookies, loggers, or similar objects designed to take a potentially-unwanted action, including by way of non-limiting example data destruction, covert data collection, browser hijacking, network proxy or redirection, covert tracking, data logging, keylogging, excessive or deliberate barriers to removal, contact harvesting, and unauthorized self-propagation.

Attacker 180 may also want to commit industrial or other espionage against secured enterprise 100, such as stealing classified or proprietary data, stealing identities, or gaining unauthorized access to enterprise resources. Thus, attacker 180's strategy may also include trying to gain physical access to one or more client devices 110 and operating them without authorization, so that an effective security policy may also include provisions for preventing such access.

In another example, a software developer may not explicitly have malicious intent, but may develop software that poses a security risk. For example, a well-known and often-exploited security flaw is the so-called buffer overrun, in which a malicious user is able to enter an overlong string into an input form and thus gain the ability to execute arbitrary instructions or operate with elevated privileges on a computing device. Buffer overruns may be the result, for example, of poor input validation or use of insecure libraries, and in many cases arise in nonobvious contexts. Thus, although not malicious himself, a developer contributing software to application repository 160 may inadvertently provide attack vectors for attacker 180. Poorly-written applications may also cause inherent problems, such as crashes, data loss, or other undesirable behavior. Because such software may be desirable itself, it may be beneficial for developers to occasionally provide updates or patches that repair vulnerabilities as they become known. However, from a security perspective, these updates and patches are essentially new objects that must themselves be validated.

Application repository 160 may represent a Windows or Apple “app store” or update service, a Unix-like repository or ports collection, or other network service providing users 120 the ability to interactively or automatically download and install applications on client devices 110. If application repository 160 has security measures in place that make it difficult for attacker 180 to distribute overtly malicious software, attacker 180 may instead stealthily insert vulnerabilities into apparently-beneficial applications.

In some cases, secured enterprise 100 may provide policy directives that restrict the types of applications that can be installed from application repository 160. Thus, application repository 160 may include software that is not negligently developed and is not malware, but that is nevertheless against policy. For example, some enterprises restrict installation of entertainment software like media players and games. Thus, even a secure media player or game may be unsuitable for an enterprise computer. Security administrator 150 may be responsible for distributing a computing policy consistent with such restrictions and enforcing it on client devices 110.

Secured enterprise 100 may also contract with or subscribe to a security services provider 190, which may provide security services, updates, antivirus definitions, patches, products, and services. McAfee®, Inc. is a non-limiting example of such a security services provider that offers comprehensive security and antivirus solutions. In some cases, security services provider 190 may include a threat intelligence capability such as the global threat intelligence (GTI™) database provided by McAfee Inc. Security services provider 190 may update its threat intelligence database by analyzing new candidate malicious objects as they appear on client networks and characterizing them as malicious or benign.

In another example, secured enterprise 100 may simply be a family, with parents assuming the role of security administrator 150. The parents may wish to protect their children from undesirable content, such as pornography, adware, spyware, age-inappropriate content, advocacy for certain political, religious, or social movements, or forums for discussing illegal or dangerous activities, by way of non-limiting example. In this case, the parent may perform some or all of the duties of security administrator 150.

When a new object is first encountered on the network, security policies may initially treat it as “gray” or “suspect.” As a first line of defense, a security appliance in cluster 142 may query security services provider 190 to see if the new object has a globally-recognized reputation. If so, a local reputation may be generated based on that global reputation. If not, the object is completely new and may be treated as a “candidate malicious object,” meaning that its status is unknown, and it may therefore be a malicious object. At a minimum, the new object may be proscribed in its access to protected resources until its reputation can be established. This may mean that extra permission from a user 120 or security administrator 150 is required for the candidate malicious object to access protected resources.

The candidate malicious object may also be subjected to additional rigorous security analysis, particularly if it is a new object with no global reputation, or if it is an executable object. This may include, for example, submitting the object to an internal security audit, or to security services provider 190, for deep analysis. This may include running the object in a sandbox environment, expert status analysis, or other security techniques. These may help to establish a new reputation for the object.

If the object is permitted to operate on the network and malicious behavior is observed, the object may be tagged as malicious object 182. Remedial action may then be taken as appropriate or necessary. Thus, it is a goal of users 120 and security administrator 150 to configure and operate client devices 110, workload cluster 142, and enterprise network 170 so as to exclude all malicious objects, and to promptly and accurately classify candidate malicious objects.

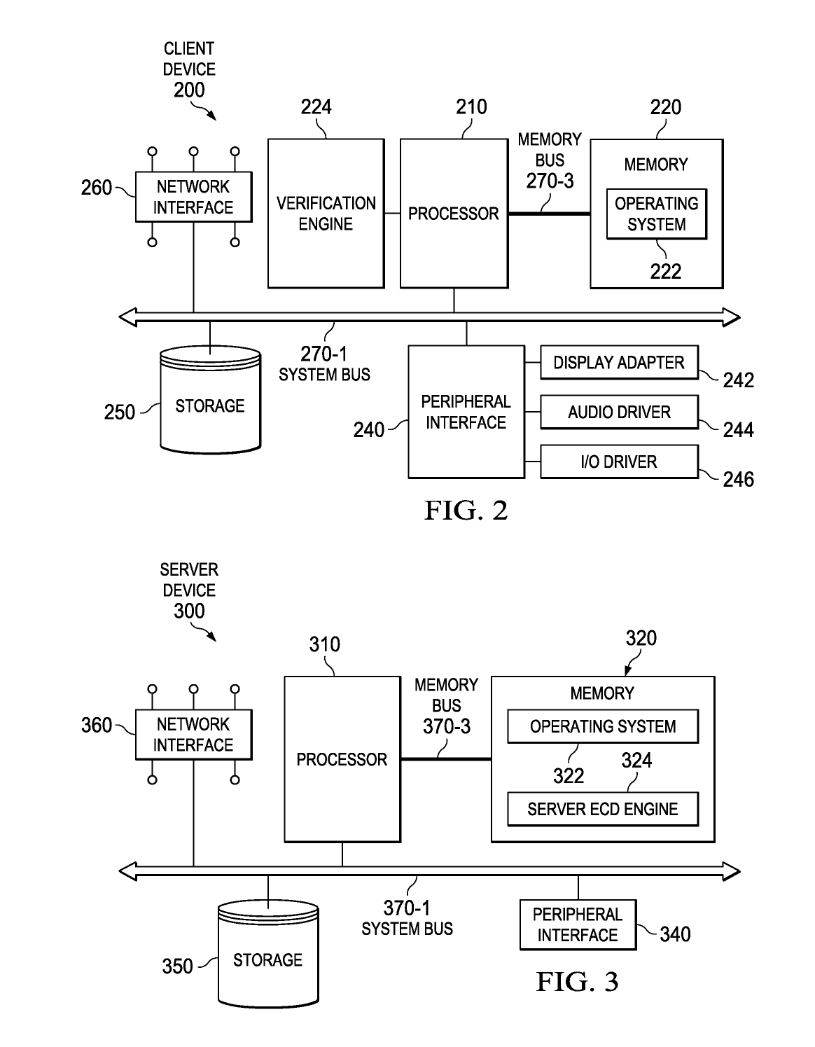

FIG. 2 is a block diagram of client device 200 according to one or more examples of the present specification. Computing device 200 may be any suitable computing device. In various embodiments, a “computing device” may be or comprise, by way of non-limiting example, a computer, workstation, server, mainframe, virtual machine (whether emulated or on a “bare-metal” hypervisor), embedded computer, embedded controller, embedded sensor, personal digital assistant, laptop computer, cellular telephone, IP telephone, smart phone, tablet computer, convertible tablet computer, computing appliance, network appliance, receiver, wearable computer, handheld calculator, or any other electronic, microelectronic, or microelectromechanical device for processing and communicating data. Any computing device may be designated as a host on the network. Each computing device may refer to itself as a “local host,” while any computing device external to it may be designated as a “remote host.”

In certain embodiments, client devices 110 may all be examples of computing devices 200.

Computing device 200 includes a processor 210 connected to a memory 220, having stored therein executable instructions for providing an operating system 222 and at least software portions of a ECD engine 224. Other components of client device 200 include a storage 250, network interface 260, and peripheral interface 240. This architecture is provided by way of example only, and is intended to be non-exclusive and non-limiting. Furthermore, the various parts disclosed are intended to be logical divisions only, and need not necessarily represent physically separate hardware and/or software components. Certain computing devices provide main memory 220 and storage 250, for example, in a single physical memory device, and in other cases, memory 220 and/or storage 250 are functionally distributed across many physical devices. In the case of virtual machines or hypervisors, all or part of a function may be provided in the form of software or firmware running over a virtualization layer to provide the disclosed logical function. In other examples, a device such as a network interface 260 may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block. As used throughout this specification, “logic elements” may include hardware, external hardware (digital, analog, or mixed-signal), software, reciprocating software, services, drivers, interfaces, components, modules, algorithms, sensors, components, firmware, microcode, programmable logic, or objects that can coordinate to achieve a logical operation.

In an example, processor 210 is communicatively coupled to memory 220 via memory bus 270-3, which may be for example a direct memory access (DMA) bus by way of example, though other memory architectures are possible, including ones in which memory 220 communicates with processor 210 via system bus 270-1 or some other bus. Processor 210 may be communicatively coupled to other devices via a system bus 270-1. As used throughout this specification, a “bus” includes any wired or wireless interconnection line, network, connection, bundle, single bus, multiple buses, crossbar network, single-stage network, multistage network or other conduction medium operable to carry data, signals, or power between parts of a computing device, or between computing devices. It should be noted that these uses are disclosed by way of non-limiting example only, and that some embodiments may omit one or more of the foregoing buses, while others may employ additional or different buses.

In various examples, a “processor” may include any combination of logic elements operable to execute instructions, whether loaded from memory, or implemented directly in hardware, including by way of non-limiting example a microprocessor, digital signal processor, field-programmable gate array, graphics processing unit, programmable logic array, application-specific integrated circuit, or virtual machine processor. In certain architectures, a multi-core processor may be provided, in which case processor 210 may be treated as only one core of a multi-core processor, or may be treated as the entire multi-core processor, as appropriate. In some embodiments, one or more co-processor may also be provided for specialized or support functions.

Processor 210 may be connected to memory 220 in a DMA configuration via DMA bus 270-3. To simplify this disclosure, memory 220 is disclosed as a single logical block, but in a physical embodiment may include one or more blocks of any suitable volatile or non-volatile memory technology or technologies, including for example DDR RAM, SRAM, DRAM, cache, L1 or L2 memory, on-chip memory, registers, flash, ROM, optical media, virtual memory regions, magnetic or tape memory, or similar. In certain embodiments, memory 220 may comprise a relatively low-latency volatile main memory, while storage 250 may comprise a relatively higher-latency non-volatile memory. However, memory 220 and storage 250 need not be physically separate devices, and in some examples may represent simply a logical separation of function. It should also be noted that although DMA is disclosed by way of non-limiting example, DMA is not the only protocol consistent with this specification, and that other memory architectures are available.

Storage 250 may be any species of memory 220, or may be a separate device. Storage 250 may include one or more non-transitory computer-readable mediums, including by way of non-limiting example, a hard drive, solid-state drive, external storage, redundant array of independent disks (RAID), network-attached storage, optical storage, tape drive, backup system, cloud storage, or any combination of the foregoing. Storage 250 may be, or may include therein, a database or databases or data stored in other configurations, and may include a stored copy of operational software such as operating system 222 and software portions of ECD engine 224. Many other configurations are also possible, and are intended to be encompassed within the broad scope of this specification.

Network interface 260 may be provided to communicatively couple client device 200 to a wired or wireless network. A “network,” as used throughout this specification, may include any communicative platform operable to exchange data or information within or between computing devices, including by way of non-limiting example, an ad-hoc local network, an internet architecture providing computing devices with the ability to electronically interact, a plain old telephone system (POTS), which computing devices could use to perform transactions in which they may be assisted by human operators or in which they may manually key data into a telephone or other suitable electronic equipment, any packet data network (PDN) offering a communications interface or exchange between any two nodes in a system, or any local area network (LAN), metropolitan area network (MAN), wide area network (WAN), wireless local area network (WLAN), virtual private network (VPN), intranet, or any other appropriate architecture or system that facilitates communications in a network or telephonic environment.

ECD engine 224, in one example, is operable to carry out computer-implemented methods as described in this specification. ECD engine 224 may include one or more tangible non-transitory computer-readable mediums having stored thereon executable instructions operable to instruct a processor to provide an ECD engine 224. As used throughout this specification, an “engine” includes any combination of one or more logic elements, of similar or dissimilar species, operable for and configured to perform one or more methods provided by the engine. Thus, ECD engine 224 may comprise one or more logic elements configured to provide methods as disclosed in this specification. In some cases, ECD engine 224 may include a special integrated circuit designed to carry out a method or a part thereof, and may also include software instructions operable to instruct a processor to perform the method. In some cases, ECD engine 224 may run as a “daemon” process. A “daemon” may include any program or series of executable instructions, whether implemented in hardware, software, firmware, or any combination thereof, that runs as a background process, a terminate-and-stay-resident program, a service, system extension, control panel, bootup procedure, BIOS subroutine, or any similar program that operates without direct user interaction. In certain embodiments, daemon processes may run with elevated privileges in a “driver space,” or in ring 0, 1, or 2 in a protection ring architecture. It should also be noted that ECD engine 224 may also include other hardware and software, including configuration files, registry entries, and interactive or user-mode software by way of non-limiting example.

In one example, ECD engine 224 includes executable instructions stored on a non-transitory medium (including hardware-based instructions, which may include one or both of sequential or combinatorial logic in conjunction with or in addition to software-programmable instructions) operable to perform a method according to this specification. At an appropriate time, such as upon booting client device 200 or upon a command from operating system 222 or a user 120, processor 210 may retrieve a copy of the instructions from storage 250 and load it into memory 220. Processor 210 may then iteratively execute the instructions of ECD engine 224 to provide the desired method.

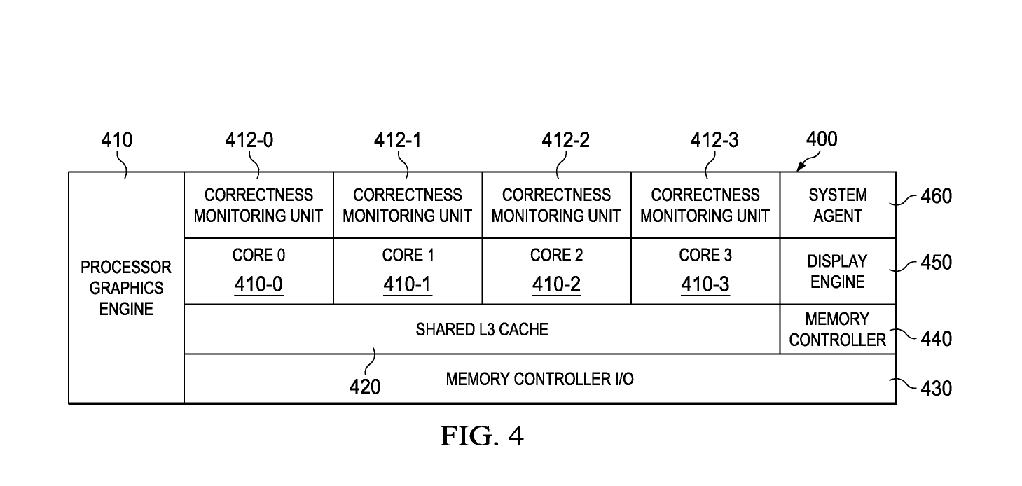

In another example, ECD engine 224 includes a hardware-only CMU 412 (FIG. 4), which may include combinatorial logic or sequential logic that performs the operations of ECD engine 224 at hardware speeds. In this case ECD engine 224 may be tightly coupled with a processing core, so that it can interrupt execution of an instruction if that instruction does not pass analysis by ECD engine 224. Note that in this case, the “non-transitory medium” of the preceding example may in fact be instructions (i.e., hardware instructions) stored on a non-transitory medium (e.g., the semiconductor substrate of the processor) that are executed not by being loaded from memory into the processor, but that are executed by the processor as part of the processor logic.

Peripheral interface 240 may be configured to interface with any auxiliary device that connects to client device 200 but that is not necessarily a part of the core architecture of client device 200. A peripheral may be operable to provide extended functionality to client device 200, and may or may not be wholly dependent on client device 200. In some cases, a peripheral may be a computing device in its own right. Peripherals may include input and output devices such as displays, terminals, printers, keyboards, mice, modems, data ports (e.g., serial, parallel, USB, Firewire, or similar), network controllers, optical media, external storage, sensors, transducers, actuators, controllers, data acquisition buses, cameras, microphones, speakers, or external storage by way of non-limiting example.

In one example, peripherals include display adapter 242, audio driver 244, and input/output (I/O) driver 246. Display adapter 242 may be configured to provide a human-readable visual output, such as a command-line interface (CLI) or graphical desktop such as Microsoft Windows, Apple OSX desktop, or a Unix/Linux X Window System-based desktop. Display adapter 242 may provide output in any suitable format, such as a coaxial output, composite video, component video, VGA, or digital outputs such as DVI or HDMI, by way of nonlimiting example. In some examples, display adapter 242 may include a hardware graphics card, which may have its own memory and its own graphics processing unit (GPU). Audio driver 244 may provide an interface for audible sounds, and may include in some examples a hardware sound card. Sound output may be provided in analog (such as a 3.5 mm stereo jack), component (“RCA”) stereo, or in a digital audio format such as S/PDIF, AES3, AES47, HDMI, USB, Bluetooth or Wi-Fi audio, by way of non-limiting example.

FIG. 3 is a block diagram of a server-class device 300 according to one or more examples of the present specification. Server 300 may be any suitable computing device, as described in connection with FIG. 2. In general, the definitions and examples of FIG. 2 may be considered as equally applicable to FIG. 3, unless specifically stated otherwise. Server 300 is described herein separately to illustrate that in certain embodiments, logical operations according to this specification may be divided along a client-server model, wherein client device 200 provides certain localized tasks, while server 300 provides certain other centralized tasks. In contemporary practice, server 300 is more likely than client device 200 to be provided as a “headless” VM running on a computing cluster, or as a standalone appliance, though these configurations are not required.

Server 300 includes a processor 310 connected to a memory 320, having stored therein executable instructions for providing an operating system 322 and at least software portions of a ECD server engine 324. Other components of server 300 include a storage 350, network interface 360, and peripheral interface 340. As described in FIG. 2, each logical block may be provided by one or more similar or dissimilar logic elements.

In an example, processor 310 is communicatively coupled to memory 320 via memory bus 370-3, which may be for example a direct memory access (DMA) bus. Processor 310 may be communicatively coupled to other devices via a system bus 370-1.

Processor 310 may be connected to memory 320 in a DMA configuration via DMA bus 370-3, or via any other suitable memory configuration. As discussed in FIG. 2, memory 320 may include one or more logic elements of any suitable type.

Storage 350 may be any species of memory 320, or may be a separate device, as described in connection with storage 250 of FIG. 2. Storage 350 may be, or may include therein, a database or databases or data stored in other configurations, and may include a stored copy of operational software such as operating system 322 and software portions of ECD server engine 324.

Network interface 360 may be provided to communicatively couple server 140 to a wired or wireless network, and may include one or more logic elements as described in FIG. 2.

ECD server engine 324 is an engine as described in FIG. 2 and, in one example, includes one or more logic elements operable to carry out computer-implemented methods as described in this specification. Software portions of ECD server engine 324 may run as a daemon process.

ECD server engine 324 may include one or more non-transitory computer-readable mediums having stored thereon executable instructions operable to instruct a processor to provide a ECD security engine 324. At an appropriate time, such as upon booting server 140 or upon a command from operating system 322 or a user 120 or security administrator 150, processor 310 may retrieve a copy of ECD server engine 324 (or software portions thereof) from storage 350 and load it into memory 320. Processor 310 may then iteratively execute the instructions of ECD server engine 324 to provide the desired method.

In certain examples, ECD server engine 324 may be configured to receive a program-under-analysis and to analyze the program as described herein. This may be a completely automated analysis, a completely human-driven analysis wherein ECD server engine 324 receives only inputs from a human user, or any combination of the two. After completing the analysis, ECD server engine 324 stores the ECD, such as in a central ECD repository, or by distributing the ECD to one or more network objects that require the ECD for running the program. Note that the “program” may be any suitable executable object, including a library, subroutine, or other portion of a larger program.

Peripheral interface 340 may be configured to interface with any auxiliary device that connects to server 300 but that is not necessarily a part of the core architecture of server 300. Peripherals may include, by way of non-limiting examples, any of the peripherals disclosed in FIG. 2. In some cases, server 300 may include fewer peripherals than client device 200, reflecting that it may be more focused on providing processing services rather than interfacing directly with users.

FIG. 4 is a block diagram of a microprocessor according to one or more examples of the present specification. Processor 400 may be an example of any suitable processor, such as processor 210 of FIG. 2 or processor 310 of FIG. 3. It should also be noted that although a central processing unit (CPU) is provided as an example for purposes of illustration, any suitable type of programmable logic device may be used, including any that comports with the definition of a “processor” as disclosed herein.

In this example, processor 400 is a four-core microprocessor. Specifically, processor 400 includes core 0 410-0, core 1 410-1, core 2 410-2, and core 3 410-3. According to common industry practice, each core 410 may include separate registers, arithmetic logic unit, combinatorial logic, sequential logic, and other core processor components. In this example, each core 410 also includes a correctness monitoring unit (CMU) 412. Specifically, core 0 410-0 includes correctness monitoring unit 412-0. Core 1 410-1 includes correctness monitoring unit 412-1. Core 2 410-2 includes correctness monitoring unit 412-2. Core 3 410-3 includes correctness monitoring unit 412-3. CMUs 412 may be configured to operate in connection with and be tightly integrated with cores 410, so that an instruction can be interrupted, such as by throwing an exception, if the instruction is found to be unsafe.

Processor 400 also includes certain shared elements, such as a processor graphics engine 410, and as shared L3 cache 420, a memory controller input output unit 430, a memory controller 440, a display engine 450, and a system agent 460. These are disclosed by way of nonlimiting example for illustration purposes only. It should be recognized that many different processors, with many different architectures are available, and that the term “processor” used herein is not intended to be limited to this one illustrative example. As discussed above, there are many types of processors, some of which are not a CPU as in this example, and they are intended to be included within the broad scope of a “processor” as used herein.

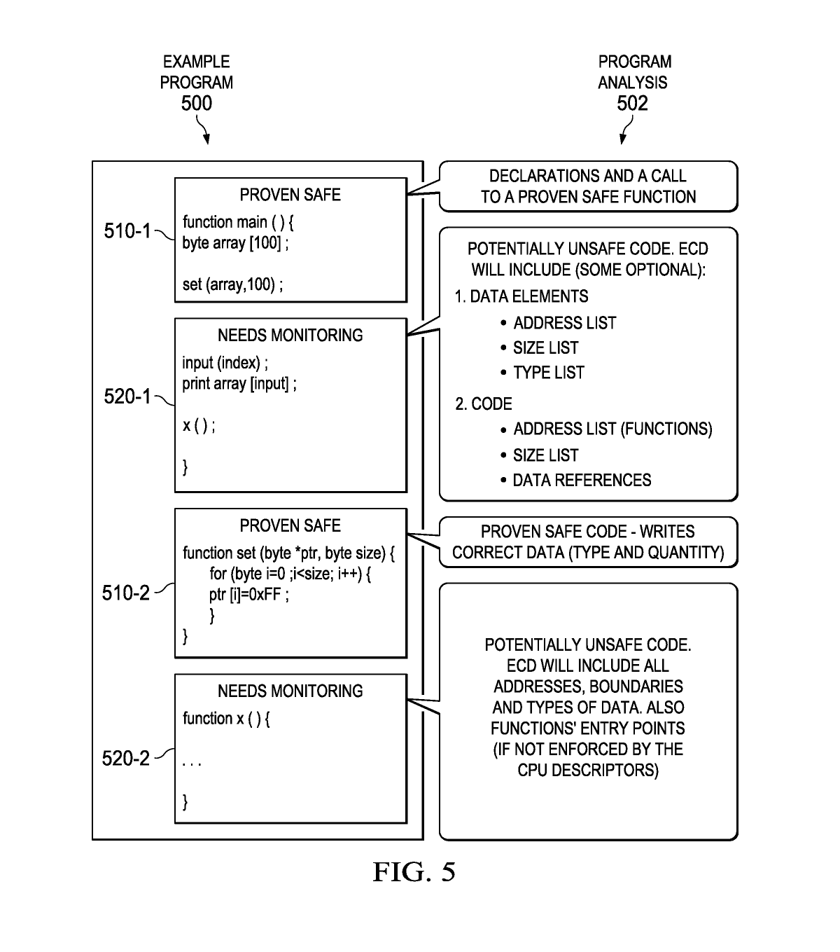

Turning to FIG. 5, a program verification operation is disclosed. For imperative and event driven programming language, the control flow is expressed in source code as procedures and event handlers. In some examples, extraction of the control flow graph is relatively straightforward, though it may be complicated by the need to also track data in pointers (especially function pointers, which affect the code flow). Other types of programming languages, including declarative languages like SQL, or those describing data flows like the HDL, are all ultimately converted into CPU commands, which are imperative and event driven, such as in the Intel IA architecture.

FIG. 5 discloses an example program 500, including a program analysis 502. Example program 500 is broken into four blocks. Specifically, proven safe blocks 510-1 and 510-2 are blocks that were previously verified with formal proof methods. On the other hand, “needs monitoring” blocks 520-1 and 520-2 were not or could not be proved according to formal methods. Needs monitoring blocks 520 may not be subject to formal proof, because they may relay rely upon external inputs that cannot be proved or whose state cannot be known at analysis time. In other examples, these blocks may be subject to formal proof, but formal proof may not be practical within this particular context. Thus, for whatever reason, needs monitoring blocks 520 have not been formally proven.

By way of example, proven block 510-1 simply contains safe function and variable declarations, and a call to a proven safe function, specifically “set.” Thus, block 510-1 does not require monitoring. This block can be assumed to be safe, and in one example may be permitted to execute without interference from or interaction with CMU 412.

In contrast to block 510-1, block 520-1 contains potentially unsafe code. This block has not been formally proved; however, it may have been subjected to previous analysis, so as to generate an ECD. In this case, the ECD may include, by way of nonlimiting example, data elements, such as address list size list and type list, as well as code, including an address list of functions, size list, and data references. With these data, CMU 412 can monitor execution of block 520-1 to ensure that execution follows established rules.

Safe block 510-2 has, like block 510-1, been proven safe. This code writes correct data of the correct type and quantity. Because this function does not rely on external inputs whose state is unknown at analysis time, and because its logic is reasonably subject to formal proof, it may be assumed safe and may be allowed to execute without interference from CMU 412.

Finally, block 520-2 is not proven safe, and thus must be monitored by CMU 412. This block contains potentially unsafe code, but like block 520-1, may have been subjected to some degree of prior analysis so that an ECD is available. The ECD may include all addresses, boundaries and types of data. Furthermore, the ECD may include function entry points if not enforced by CPU descriptors. Thus, during execution, CMU 412 monitors the execution of block 520 to ensure that it is correct.

It should be noted that the security architecture of processor 400 may affect the level of details required in an ECD. Thus, the example disclosed here should not be considered limiting. For example, if processor 400 strongly enforces data types through tagging, a less detailed ECD may be possible. Similarly, if processor 400 has code integrity controls (e.g. only allows entering certain code blocks via specified gates, such as in an Intel® Software Guard Extension (SGX) instruction set for creating secured enclaves and trusted execution environments) a less detailed ECD may again be possible (e.g., data flows related to tracking function pointers may be omitted from the ECD).

When source code is not available, an equivalent ECD may be extracted from the program's binary code. The complexity of the extraction may reduce with more secure processor architectures providing code isolation (e.g. via descriptors) or data type safety. In this case, the first “potentially unsafe” code block (e.g., 510-1) may actually be always safe if “index” limits are externally enforced in input( ) functions. Run-time control will be able to monitor this.

It may be beneficial to incorporate ECD management with the OS program loader and/or OS dispatcher. The OS program loader determines the location of program modules in memory and will know how to translate the ECD data into real RAM addresses (virtual or physical, as required by a specific CPU). Also, the as dispatcher (or hypervisor) may determine which thread is going to execute and will activate the ECD portion pertaining to the correct thread.

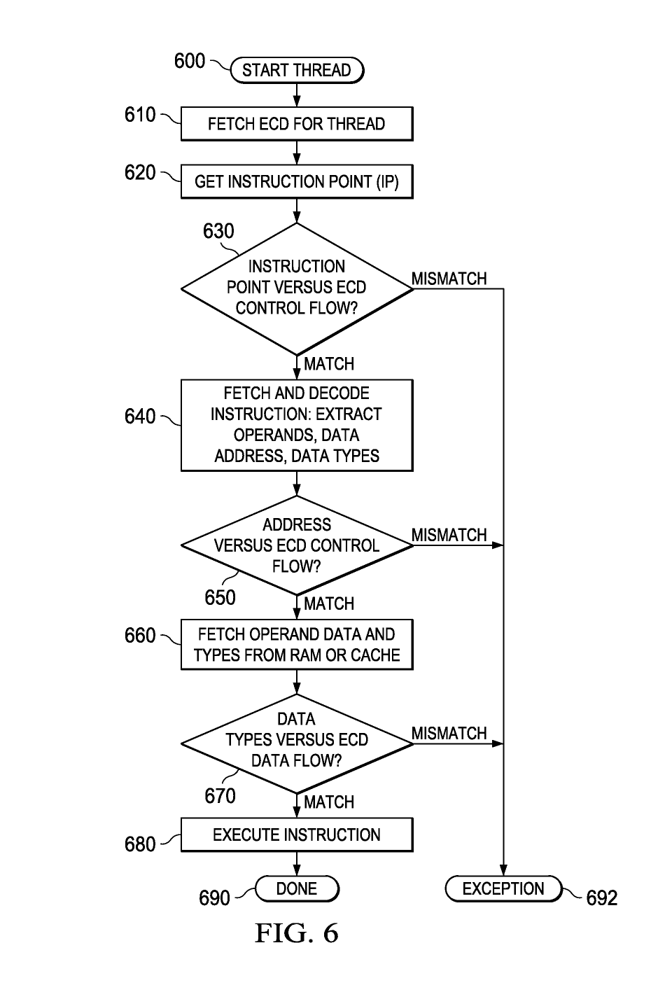

FIG. 6 is a flowchart of a method 600 according to one or more examples of the present specification.

In block 600, a thread starts.

In block 610, a core 410 of processor 400 fetches an ECD for the thread that was started in block 600. This may include retrieving a local copy, or requesting a copy from a server 300, which may be a physical device or a virtual machine running in workload cluster 142.

In block 620, CMU 412 gets the instruction pointer for the next instruction.

In decision block 630, CMU 412 compares the instruction pointer to the ECD control flow. If there is a mismatch, control passes to off-page connector 1. On FIG. 6B, off-page connector 1 routes to an exception 692. Once an exception is thrown, the method is done.

Returning to block 630, if the instruction pointer and the ECD control flow match, then control passes to block 640. In block 640, control logic of the core 410 fetches and decodes the instruction, extracting operands, data addresses, and data types. Core 410 may provide the operands, addresses, and types to CMU 412.

In decision block 650, CMU 412 compares the instruction address to the ECD control flow. If there is a mismatch, then control passes again to off-page connector 1, and in block 692 an exception is thrown.

Returning to block 650, if the address and ECD control flow match, then control passes off-page connector 2.

Turning to FIG. 6B, from off-page connector 2, in block 660, core 410 fetches operands and types from RAM or cache. Core 410 may provide the data types and ECD data to CMU 412.

In decision block 670, CMU 412 compares the data types to the ECD data flow. If there is a mismatch, then in block 692, an exception is thrown. However, if there is a match, then control passes to block 680.

In block 680, the instruction has been verified by CMU 412, and core 410 may now execute the instruction.

In block 690, the method is done.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

The particular embodiments of the present disclosure may readily include a system on chip (SOC) central processing unit (CPU) package. An SOC represents an integrated circuit (IC) that integrates components of a computer or other electronic system into a single chip. It may contain digital, analog, mixed-signal, and radio frequency functions: all of which may be provided on a single chip substrate. Other embodiments may include a multi-chip-module (MCM), with a plurality of chips located within a single electronic package and configured to interact closely with each other through the electronic package. In various other embodiments, the digital signal processing functionalities may be implemented in one or more silicon cores in Application Specific Integrated Circuits (ASICs), Field Programmable Gate Arrays (FPGAs), and other semiconductor chips.

Additionally, some of the components associated with described microprocessors may be removed, or otherwise consolidated. In a general sense, the arrangements depicted in the figures may be more logical in their representations, whereas a physical architecture may include various permutations, combinations, and/or hybrids of these elements. It is imperative to note that countless possible design configurations can be used to achieve the operational objectives outlined herein. Accordingly, the associated infrastructure has a myriad of substitute arrangements, design choices, device possibilities, hardware configurations, software implementations, equipment options, etc.

Any suitably-configured processor component can execute any type of instructions associated with the data to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof. In operation, processors may store information in any suitable type of non-transitory storage medium (for example, random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. Further, the information being tracked, sent, received, or stored in a processor could be provided in any database, register, table, cache, queue, control list, or storage structure, based on particular needs and implementations, all of which could be referenced in any suitable timeframe. Any of the memory items discussed herein should be construed as being encompassed within the broad term ‘memory.’

Computer program logic implementing all or part of the functionality described herein is embodied in various forms, including, but in no way limited to, a source code form, a computer executable form, and various intermediate forms (for example, forms generated by an assembler, compiler, linker, or locator). In an example, source code includes a series of computer program instructions implemented in various programming languages, such as an object code, an assembly language, or a high-level language such as OpenCL, Fortran, C, C++, JAVA, or HTML for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

In one example embodiment, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In another example embodiment, the electrical circuits of the FIGURES may be implemented as stand-alone modules (e.g., a device with associated components and circuitry configured to perform a specific application or function) or implemented as plug-in modules into application specific hardware of electronic devices.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of the FIGURES may be combined in various possible configurations, all of which are clearly within the broad scope of this specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 (pre-AIA) or paragraph (f) of the same section (post-AIA), as it exists on the date of the filing hereof unless the words “means for” or “steps for” are specifically used in the particular claims; and (b) does not intend, by any statement in the specification, to limit this disclosure in any way that is not otherwise reflected in the appended claims.

### Example Implementations

There is disclosed in one example, a computing apparatus, comprising: a processor operable to execute a plurality of instructions comprising a program; and a verification engine, operable to: receive an execution control data (ECD) for the program; and monitor only some instructions of the program to ensure that they are consistent with the ECD.

There is further disclosed an example, wherein the verification engine comprises a correctness monitoring unit (CMU).

There is further disclosed an example, wherein the CMU is at least partly embodied in hardware of the processor.

There is further disclosed an example, wherein the CMU is fully embodied in hardware of the processor.

There is further disclosed an example, wherein the verification engine is operable to identify at least some instructions of the program as safe instructions, and to execute the safe instructions without monitoring the instructions to ensure that they are consistent with the ECD.

There is further disclosed an example, wherein monitoring execution of only some instructions of the program to ensure that they are consistent with the ECD comprises identifying at least some of the instructions as unverified instructions.

There is further disclosed an example, wherein monitoring execution of only some instructions of the program to ensure that they are consistent with the ECD comprises comparing an instruction pointer to an ECD control flow.

There is further disclosed an example, wherein monitoring execution of only some instructions of the program to ensure that they are consistent with the ECD comprises comparing address to an ECD control flow.

There is further disclosed an example, wherein monitoring execution of only some instructions of the program to ensure that they are consistent with the ECD comprises comparing a data type to an ECD control flow.

There is further disclosed an example, wherein receiving the ECD comprises receiving the ECD from a third-party source.

The computing apparatus of claim 1, wherein the verification engine is further operable to generate the ECD locally.

There is further disclosed an example, wherein the verification engine is operable to determine that at least some instructions of the program are not consistent with the ECD, and to act on the determining.

There is further disclosed an example, wherein acting on the determining comprises throwing an exception.

There is further disclosed an example of one or more tangible, non-transitory computer-readable storage mediums having stored thereon executable instructions for instructing one or more processors for providing a verification engine operable for performing any or all of the operations of the preceding examples.

There is further disclosed an example of a method of providing a verification engine comprising performing any or all of the operations of the preceding examples.

There is further disclosed an example of an apparatus comprising means for performing the method.

There is further disclosed an example wherein the means comprise a processor and a memory.

There is further disclosed an example wherein the means comprise one or more tangible, non-transitory computer-readable storage mediums.

There is further disclosed an example wherein the apparatus is a computing device.

1. A computing apparatus, comprising:
a processor operable to execute a plurality of instructions comprising a program, wherein a first portion of the program is formally proven safe, and wherein a second portion of the program is designated as needing monitoring; and
a verification engine, operable to:
receive an execution control data (ECD) for the program; and
monitor only the second portion of the program to ensure that it is consistent with the ECD.

2. The computing apparatus of claim 1, wherein the verification engine comprises a correctness monitoring unit (CMU).

3. The computing apparatus of claim 2, wherein the CMU is at least partly embodied in hardware of the processor.

4. The computing apparatus of claim 2, wherein the CMU is fully embodied in hardware of the processor.

5. The computing apparatus of claim 1, wherein the verification engine is operable to identify at least some instructions of the program as safe instructions, and to execute the safe instructions without monitoring the instructions to ensure that they are consistent with the ECD.

6. The computing apparatus of claim 1, wherein the second portion of the program comprises unverified instructions.

7. The computing apparatus of claim 1, wherein monitoring the second portion of the program comprises comparing an instruction pointer to an ECD control flow.

8. The computing apparatus of claim 1, wherein monitoring the second portion of the program comprises comparing address to an ECD control flow.

9. The computing apparatus of claim 1, wherein monitoring the second portion of the program comprises comparing a data type to an ECD control flow.

10. The computing apparatus of claim 1, wherein receiving the ECD comprises receiving the ECD from a third-party source.

11. The computing apparatus of claim 1, wherein the verification engine is further operable to generate the ECD locally.

12. The computing apparatus of claim 1, wherein the verification engine is operable to determine that at least some of instructions of the program are not consistent with the ECD, and to act on the determining.

13. The computing apparatus of claim 10, wherein acting on the determining comprises throwing an exception.

14. One or more tangible, non-transitory computer-readable storage mediums having stored thereon executable instructions for providing a monitoring engine operable to:
receive an execution control data (ECD) for a program comprising a plurality of instructions, wherein a first portion of the program is formally proven safe, and wherein a second portion of the program is designated as needing monitoring; and
monitor execution of only the second portion of the program to ensure that it is consistent with the ECD.

15. The one or more tangible, non-transitory computer-readable storage mediums of claim 14, wherein the verification engine comprises a correctness monitoring unit (CMU).

16. The one or more tangible, non-transitory computer-readable storage mediums of claim 15, wherein the CMU is at least partly embodied in hardware of the processor.

17. The one or more tangible, non-transitory computer-readable storage mediums of claim 15, wherein the CMU is fully embodied in hardware of the processor.

18. The one or more tangible, non-transitory computer-readable storage mediums of claim 14, wherein the verification engine is operable to identify at least some instructions of the program as safe instructions, and to execute the safe instructions without monitoring the instructions to ensure that they are consistent with the ECD.

19. The one or more tangible, non-transitory computer-readable storage mediums of claim 14, wherein monitoring monitoring the second portion of the program comprises identifying at least some of the instructions as unverified instructions.

20. The one or more tangible, non-transitory computer-readable storage mediums of claim 14, wherein monitoring the second portion of the program comprises comparing an instruction pointer to an ECD control flow.

21. The one or more tangible, non-transitory computer-readable storage mediums of claim 14, wherein monitoring the second portion of the program comprises comparing address to an ECD control flow.

22. The one or more tangible, non-transitory computer-readable storage mediums of claim 14, wherein monitoring the second portion of the program comprises comparing a data type to an ECD control flow.

23. The one or more tangible, non-transitory computer-readable storage mediums of claim 14, wherein the verification engine is operable to determine that at least some instructions of the program are not consistent with the ECD, and to throw an exception.

24. A computer-implemented method of providing a monitoring engine, comprising:
receiving an execution control data (ECD) for a program comprising a plurality of instructions, wherein a first portion of the program is formally proven safe, and wherein a second portion of the program is designated as needing monitoring; and
monitoring execution of only the second portion of the program to ensure that it is consistent with the ECD.

25. The method of claim 24, further comprising identifying at least some instructions of the program as safe instructions, and to execute the safe instructions without monitoring the instructions to ensure that they are consistent with the ECD.
